(19) United States
(12) Patent Application Publication
(10) Pub. No.: US 2022/0357457 A1
(43) Pub. Date: Nov. 10, 2022

(54) OPTICAL MEASUREMENT APPARATUS FOR DETERMINING OBJECT INFORMATION OF OBJECTS IN AT LEAST ONE MONITORING REGION

(71) Applicant: Valeo Schalter und Sensoren GmbH, Bietigheim-Bissingen (DE)

(72) Inventors: Thorsten Beuth, Bietigheim-Bissingen (DE); Urs Zywietz, Bietigheim-Bissingen (DE)

(73) Assignee: Valeo Schalter und Sensoren GmbH, Bietigheim-Bissingen (DE)

(21) Appl. No.: 17/624,459

(22) PCT Filed: Jun. 30, 2020
(86) PCT No.: PCT/EP2020/068336

§ 371 Date: Jan. 3, 2022

(30) Foreign Application Priority Data
Jul. 4, 2019 (DE) 10 2019 118 029.5

(51) Int. Cl. G01S 17/931; G01S 7/481; G01S 17/89

(52) U.S. Cl. CPC G01S 17/931; G01S 7/481; G01S 17/89

(57) ABSTRACT

An optical measurement apparatus for determining object information of objects in at least one monitoring region is disclosed. The apparatus has a reception device for receiving light signals coming from at least one object. The reception device comprises at least one electro-optical receiver (34) for converting light signals into electrical signals. At least one light diffraction element (52) is arranged in a receiver light path of the at least one reception device upstream of the at least one receiver (34). The receiver (34) has a plurality of reception regions (40) that are arranged one behind another viewed in the direction of at least one receiver axis (42) and that is evaluated separately with respect to the respectively received light intensity. At least one boundary periphery (54) of at least one light diffraction element (52) at least regionally does not extend perpendicularly to the at least one receiver axis (42) viewed in the projection onto the receiver (34).

### TECHNICAL FIELD

The invention relates to an optical measurement apparatus for determining object information of objects in at least one monitoring region, having at least one reception device for receiving light signals coming from at least one object,
wherein the at least one reception device comprises at least one electro-optical receiver for converting light signals into electrical signals,
and wherein at least one light diffraction element is arranged in a receiver light path of the at least one reception device upstream of the at least one receiver.

### PRIOR ART

DE 10 2011 107 585 A1 discloses an optical measurement apparatus comprising a housing. A transmission window is formed in a front wall of the housing. Pulsed laser light is emitted through the transmission window to the outside. The housing moreover comprises a reception window in the front wall below the transmission window. Laser beams reflected by objects detected in the vehicle's surroundings are received via the reception window and processed by a reception unit arranged in the housing. The reception unit comprises a receiver printed circuit board, on which for example an optical receiver in the form of a detector is arranged, and moreover also has a reception optical unit, which can have a reception lens and a deflection mirror as a reception deflection mirror. The optical receiver is preferably an APD diode. The reception lens has a quadrangular embodiment with respect to its perimeter contour.

It has been found that diffraction effects at straight peripheries in particular of quadrangular reception lenses can influence the full illumination of the optical receiver with the light signals.

As is known, lines and edges generate diffraction patterns according to their alignment. This effect is known from single-slit experiments. Accordingly, diffraction effects can arise due to opaque objects. Boundaries of light openings and opaque objects in the receiver light path consequently produce diffraction patterns.

The invention is based on the object of designing a measurement apparatus of the type mentioned in the introductory part, in which the determination of object information, in particular the full illumination of the optical receiver with light signals, can be improved.

### DISCLOSURE OF THE INVENTION

This object is achieved according to the invention in that
the at least one receiver has a plurality of reception regions that are arranged one behind another viewed in the direction of at least one receiver axis and that can be evaluated separately with respect to the respectively received light intensity,
and at least one boundary periphery of at least one light diffraction element at least regionally does not extend perpendicularly to the at least one receiver axis viewed in the projection onto the at least one receiver.

According to the invention, the at least one receiver has a plurality of reception regions onto which the light signals can be incident and which can be evaluated separately. A spatially resolved measurement is possible with the aid of the plurality of reception regions. The directions from which the captured light signals come and in which the corresponding objects are located can be ascertained owing to the respective assignment of the light signals to the reception regions.

Light within the meaning of the invention is understood to mean electromagnetic radiation both visible and invisible to the human eye.

The reception regions are arranged one behind another along at least one receiver axis. Since at least one boundary periphery of at least one light diffraction element at least regionally does not extend perpendicularly to at least one receiver axis, corresponding diffraction effects in the direction of the at least one receiver axis are reduced. In this way, what is known as “crosstalk” between adjacent reception regions is reduced.

According to the invention, a symmetry of the optical measurement apparatus is utilized to influence the diffraction direction of diffraction effects and to reduce in this way crosstalk of light signals to a plurality of reception regions.

Furthermore, the optical measurement apparatus can advantageously have at least one transmission device. The transmission device can be used to produce light signals.

In addition, the optical measurement apparatus can advantageously have at least one light signal deflection device. The light signal deflection device can be used to direct light signals from the at least one transmission device into the at least one monitoring region and/or to direct light signals from the at least one monitoring region to the at least one reception device.

Furthermore, the optical measurement apparatus can advantageously have at least one control and evaluation device. The control and evaluation device can be used to control at least one transmission device and/or at least one reception device and/or at least one light signal deflection device. Using the control and evaluation device, electrical signals that are coming from the at least one reception device and can characterize in particular object information can furthermore be received, evaluated and/or possibly in particular passed on to a driver assistance system.

The at least one measurement apparatus can advantageously operate in accordance with a time-of-flight method, in particular a light pulse time-of-flight method. Optical measurement apparatuses operating in accordance with the light pulse time-of-flight method can be designed and referred to as time-of-flight (TOF) systems, light detection and ranging (LiDAR) systems, laser detection and ranging (LaDAR) systems or the like. Here, a time of flight from transmission of a transmission signal, in particular a light pulse, using a transmitter and receipt of the corresponding reflected transmission signal using a receiver is measured, and the distance between the measurement apparatus and the recognized object is ascertained therefrom.

Advantageously, the measurement apparatus can be designed as a scanning system. In this case, a monitoring region can be sampled, that is to say, scanned, with transmission signals. For this purpose, the corresponding transmission signals, in particular transmission beams, can be pivoted with respect to their propagation direction over the monitoring region. In this case, at least one deflection device, in particular a scanning device, a deflection mirror device or the like, can be used. Alternatively, the measurement apparatus can be designed as a flash LiDAR. The monitoring region can in this case be simultaneously fully illuminated with at least one light signal.

Advantageously, the measurement apparatus can be designed as a laser-based distance measurement system. The laser-based distance measurement system can have at least one laser as the light source. The at least one laser can be used to transmit in particular pulsed transmission beams as transmission signals. The laser-based distance measurement system can advantageously be a laser scanner. A laser scanner can be used to sample a monitoring region with an in particular pulsed laser beam.

The invention can be used in a vehicle, in particular a motor vehicle. The invention can advantageously be used in a land-based vehicle, in particular a passenger vehicle, a truck, a bus, a motorcycle or the like, an aircraft and/or a watercraft. The invention can also be used in vehicles that can be operated autonomously or at least partially autonomously. However, the invention is not limited to vehicles. It can also be used in stationary operation.

The measurement apparatus can advantageously be connected to at least one electronic control device of a vehicle, in particular a driver assistance system and/or a chassis control system and/or a driver information device and/or a parking assistance system and/or a gesture recognition or the like, or can be part of such a device or system. In this way, at least partially autonomous operation of the vehicle can be made possible.

The optical measurement apparatus can be used to capture standing or moving objects, in particular vehicles, persons, animals, plants, obstacles, road unevennesses, in particular potholes or rocks, roadway boundaries, traffic signs, free spaces, in particular free parking spaces or the like.

In an advantageous embodiment,
at least one boundary periphery of at least one light diffraction element can be at least one periphery of at least one optical lens,
and/or at least one boundary periphery of at least one light diffraction element can be a periphery of a stop or mask,
and/or at least one boundary periphery of at least one light diffraction element can be a periphery of a heating wire,
and/or at least one boundary periphery of at least one light diffraction element can be a periphery of a window of a housing of the measurement apparatus.

In this way, functional components of the measurement apparatus, in particular optical lenses, stops, masks, heating wires, windows or the like, which represent light diffraction elements whose influence on the light signals can be adapted with the aid of the invention, can be arranged in the receiver light path.

Advantageously, at least one periphery of at least one optical lens can have a profile according to the invention. In this way, the light-diffractive influence can be easily adapted directly to the lens.

At least one stop or mask can advantageously be arranged at at least one optical lens. The at least one stop or mask can cover at least one periphery of the optical lens. In this way, light diffraction at the periphery of the optical lens can be prevented. Rather, the light diffraction takes place at the periphery of the at least one stop or mask. At least one periphery of the at least one stop or mask can have a profile according to the invention.

Advantageously, at least one heating wire can be arranged at a window of a housing of the measurement apparatus. In this way, the window can be temperature-controlled. The risk of the window fogging up can thus be reduced.

Advantageously, a periphery of a window in a housing of the measurement apparatus can have a profile according to the invention. In this way, the light-diffractive influence can be easily adapted directly to the window.

The window in the housing of the measurement apparatus can advantageously be arranged in the receiver light path. Light signals can pass through the window from the monitoring region to the at least one receiver.

In a further advantageous embodiment, it is possible for more than 7/10 of the extent of at least one boundary periphery of at least one light diffraction element not to extend perpendicularly to the at least one receiver axis viewed in the projection onto the at least one receiver. In this way, crosstalk to a plurality of reception regions is reduced and an extent of the at least one boundary periphery transversely to the at least one receiver axis is achieved.

Advantageously, no portion of the at least one boundary periphery may extend perpendicularly to the at least one receiver axis. In this way, crosstalk in the direction of the at least one receiver axis can be minimized.

In a further advantageous embodiment, at least one boundary periphery of at least one light diffraction element can extend at least regionally in a zigzag shape and/or at least regionally in a wave shape and/or at least regionally in a zigzag shape with flattened and/or rounded tips and/or at least regionally have a free curve profile. In this way, an extent of the at least one light diffraction element transversely to the at least one receiver axis can be achieved, wherein the extension perpendicularly to the at least one receiver axis can be minimized.

Advantageously, the profile of at least one boundary periphery may vary. In this way, the profile can be adapted more flexibly in particular to the geometry of the measurement apparatus in order to reduce an influence of the diffraction patterns with respect to the crosstalk.

In a further advantageous embodiment, the optical measurement apparatus can have a housing in which at least one reception device is arranged, and the housing can have at least one window through which light signals can pass from the monitoring region to the at least one reception device. The at least one reception device and possibly further components can be accommodated in the housing so as to be protected. The at least one window can be transmissive to light signals, in particular reception light signals. Furthermore, the at least one window can have at least one heating device, in particular at least one heating wire. With the aid of the heating device, in particular at least one heating wire, it is possible to prevent the at least one window from fogging up.

In a further advantageous embodiment, at least one receiver can have a plurality of individual reception elements with in each case at least one reception region, and/or at least one receiver can have at least one line-type or area-type arrangement of a plurality of reception regions. Individual reception elements can easily be read separately and the corresponding information can be evaluated. Line-type or area-type arrangements of a plurality of reception regions can be produced together.

At least one receiver can advantageously have, or consist of, at least one detector, in particular a line sensor or area sensor, in particular a plurality of (avalanche) photodiodes, a photodiode line, a CCD sensor or the like. Light signals can be converted quickly and accurately into corresponding electrical signals using such receivers.

In a further advantageous embodiment, at least one rectangular or square optical lens can be arranged in the receiver light path. The light signals can be imaged better onto reception regions having a line-type or area-type arrangement with rectangular or square lenses than would be possible with round optical lenses. The peripheries of the optical lens can be considered to be boundary peripheries in which diffraction patterns can be produced.

In a further advantageous embodiment, the optical measurement arrangement can be designed for determining at least one direction of at least one captured object relative to the measurement apparatus. In this way, positions and/or dimensions of objects in particular in the direction of the at least one receiver axis can be ascertained. A height and/or a width of an object can be determined with the aid of the optical measurement apparatus.

Additionally, the optical measurement apparatus can advantageously be designed for the determination of at least one distance and/or a speed of a captured object relative to the measurement apparatus. With the aid of this object information, an object can be better characterized, in particular identified. The object information may possibly be transmitted to a driver assistance system of a vehicle carrying the optical measurement apparatus, with the result that the vehicle can be operated autonomously or partially autonomously.

### BRIEF DESCRIPTION OF THE DRAWINGS

Further advantages, features and details of the invention are apparent from the following description, in which exemplary embodiments of the invention will be explained in greater detail with reference to the drawing. A person skilled in the art will also expediently consider individually the features that have been disclosed in combination in the drawing, the description and the claims and combine them to form further meaningful combinations. Schematically, in the drawings,

FIG. 1 shows a front view of a motor vehicle with an optical measurement apparatus for monitoring a monitoring region in front of the motor vehicle in the driving direction;

FIG. 2 shows a longitudinal section of an optical measurement apparatus according to a first exemplary embodiment, which can be used in the vehicle from FIG. 1;

FIG. 3 shows a view through a window of the optical measurement apparatus from FIG. 2;

FIG. 4 shows a view through a window of an optical measurement apparatus according to a second exemplary embodiment, which can be used in the vehicle from FIG. 1;

FIG. 5 shows a view through a window of an optical measurement apparatus according to a third exemplary embodiment, which can be used in the vehicle from FIG. 1;

FIG. 6 shows a view through a reception lens of the optical measurement apparatuses from FIG. 2;

FIG. 7 shows a view through a reception lens of an optical measurement apparatus according to a fourth exemplary embodiment, which can be used in the vehicle from the figure;

FIG. 8 shows a longitudinal section of an optical measurement apparatus, in which the invention is not used;

FIG. 9 shows a view through a window of the optical measurement apparatus from FIG. 8.

In the figures, identical components are provided with the same reference signs.

### EMBODIMENT(S) OF THE INVENTION

FIG. 1 illustrates a front view of a motor vehicle 10 by way of example in the form of a passenger vehicle. The motor vehicle 10 has a driver assistance system 12, with which the motor vehicle 10 can be operated autonomously or partially autonomously in a manner which is of no further interest here.

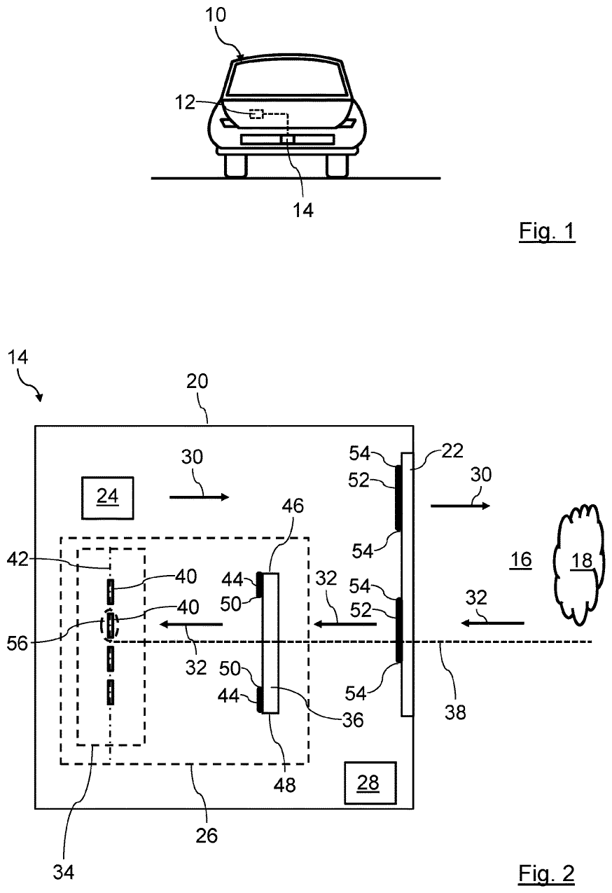

The motor vehicle 10 furthermore has an optical measurement apparatus 14, which is arranged, by way of example, in the front bumper. The optical measurement apparatus 14 can be used to monitor a monitoring region 16, designated in FIG. 2, in front of the motor vehicle 10 in the driving direction for objects 18. The optical measurement apparatus 14 can also be arranged at a different location of the motor vehicle 10 and with a different alignment.

The optical measurement apparatus 14 can be used to capture standing or moving objects 18, for example vehicles, persons, animals, plants, obstacles, road unevennesses, in particular potholes or rocks, roadway boundaries, traffic signs, free spaces, in particular free parking spaces or the like.

The optical measurement apparatus 14 can be used to ascertain object information, for example distances, directions and speeds of captured objects 18 relative to the optical measurement apparatus 14, that is to say relative to the motor vehicle 10. The measurement apparatus 14 can be designed for example as a laser-based distance measurement system, for example as a LiDAR system.

The optical measurement apparatus 14 is connected to the driver assistance system 12 for the transmission of signals. Object information of objects 18 captured with the optical measurement apparatus 14 is transmitted to the driver assistance system 12. The object information is processed with the driver assistance system 12 and can be used for controlling functions of the motor vehicle 10.

FIG. 2 shows a longitudinal section of an optical measurement apparatus 14 according to a first exemplary embodiment.

The optical measurement apparatus 14 comprises a housing 20. The housing 20 has, on its side facing the monitoring region 16, a window 22.

A transmission device 24, a reception device 26 and a control and evaluation device 28 are arranged in the housing 20.

During the operation of the measurement apparatuses 14, transmission light signals 30, for example in the form of laser pulses, are produced using the transmission device 24. The transmission light signals 30 may be invisible to the human eye, for example. The window 22 is made from a material that is transmissive to the transmission light signals 30. The transmission light signals 30 are transmitted through the window 22 into the monitoring region 16.

A light signal deflection device (not shown), for example a deflection mirror device or the like, with which the transmission light signals 30 can be steered into the monitoring region 16, can be optionally arranged in the housing 20.

The transmission light segments 30 are reflected at objects 18 in the monitoring region 16. The transmission light signals 30 reflected in the direction of the measurement apparatus 14 are below referred to as reception light signals 32 for the purposes of better differentiation. The reception light signals 32 pass through the window 22 to the reception device 26. The reception light signals 22 in the housing 20 can optionally be deflected using the deflection mirror device.

Using the reception device 26, the reception light signals 32 are converted into electrical signals and transmitted to the control and evaluation device 28. The object information, specifically the distance, the direction and the speed of the captured object 18 relative to the measurement apparatus 14, is ascertained from the captured reception light signals 32. The object information is transmitted to the driver assistance system 12 using the control and evaluation device 28.

The reception device 26 comprises, by way of example, a receiver 34 and an optical reception lens 36. The reception lens 36 and the window 22 are located in a receiver light path 38 of the receiver 34. The receiver light path 38 within the meaning of the invention is the path travelled by the reception light signals 32 coming from the object 18. For the sake of clarity, FIG. 2 indicates the receiver light path 38 merely as a dashed axis. This axis is intended to indicate the centre of the receiver light path 38. The receiver light path 38 is actually understood to mean a three-dimensional space that in FIG. 2 extends, by way of example, from the axis upwards, downwards, into the drawing plane and away from the drawing plane.

The reception lens 36 is located between the window 22 and the receiver 34. The reception light signals 32 are focused onto the receiver 34 using the reception lens 36.

The receiver 34 has a plurality of reception regions 40. The reception regions 40 can in each case be implemented as an avalanche photodiode, by way of example. The reception regions 40 are arranged one behind another viewed in the direction of a receiver axis 42. In the exemplary embodiment shown, the receiver axis 42 extends, with a normal alignment of the motor vehicle 10, as shown in FIG. 2, spatially vertically, with the result that the reception regions 40 are arranged there one above another. With the vertical arrangement of reception regions 40 according to the exemplary embodiment, spatial height information with respect to the captured object 18 can be ascertained using the receiver 34.

Rather than with separate avalanche photodiodes, the receiver 34 can also be implemented in the form of a line sensor having a plurality of image points arranged correspondingly along the receiver axis 42.

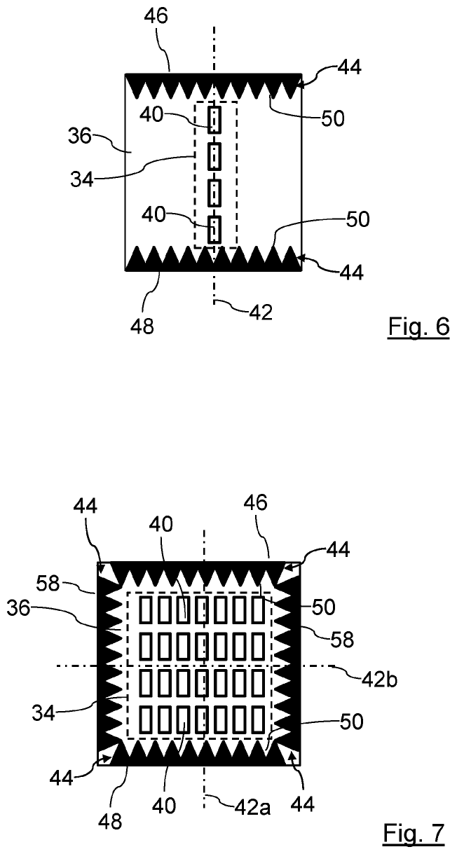

The reception lens 36 has, for example, a quadrangular, specifically a square or rectangular, design. The reception lens 36 is shown in front of the receiver 34 in FIG. 6. The illustration of the window 22 was omitted for clarity reasons in FIG. 6. The reception lens 36 is aligned such that two of its peripheries, specifically the upper periphery 46 and the lower periphery 48, extend perpendicularly to the receiver axis 42 viewed in the projection onto the receiver 34.

Two masks 44 are arranged on the reception lens 36. The masks 44 are located, by way of example, on the side of the reception lens 36 facing the receiver 34. One of the masks 44 extends along the upper periphery 46 of the reception lens 36 and covers the upper periphery 46. The other mask 44 extends along the lower periphery 48 of the reception lens 36 and covers the lower periphery 48. On their sides facing one another, the masks 44 each have a zigzag-shaped boundary periphery 50.

The masks 44 in each case act as light diffraction elements for the reception light signals 32. It is known that lines and edges produce diffraction patterns according to their alignment. Diffraction patterns that expand in the reception regions 40 in the direction of the receiver axis 42 can lead to crosstalk between the reception regions 40. None of the zigzag-shaped boundary peripheries 50 of the masks 44 extend perpendicularly to the receiver axis 42 viewed in the projection onto the receiver 34. In this way it is ensured that expansions of the diffraction patterns, brought about by the boundary peripheries 50, in the reception regions 40 in the direction of the receiver axis 42 are reduced.

By way of example, two heating wires 52 are arranged at the window 22. The heating wires 52 are located, protected with respect to the environment, for example at the inner side of the window 22 facing the interior of the housing 20. The heating wires 52 are connected to a power supply, which is not shown for the sake of clarity. The heating wires 52 can be used to control the temperature of the window 22 in order to prevent for example that the window 22 fogs up or ices over.

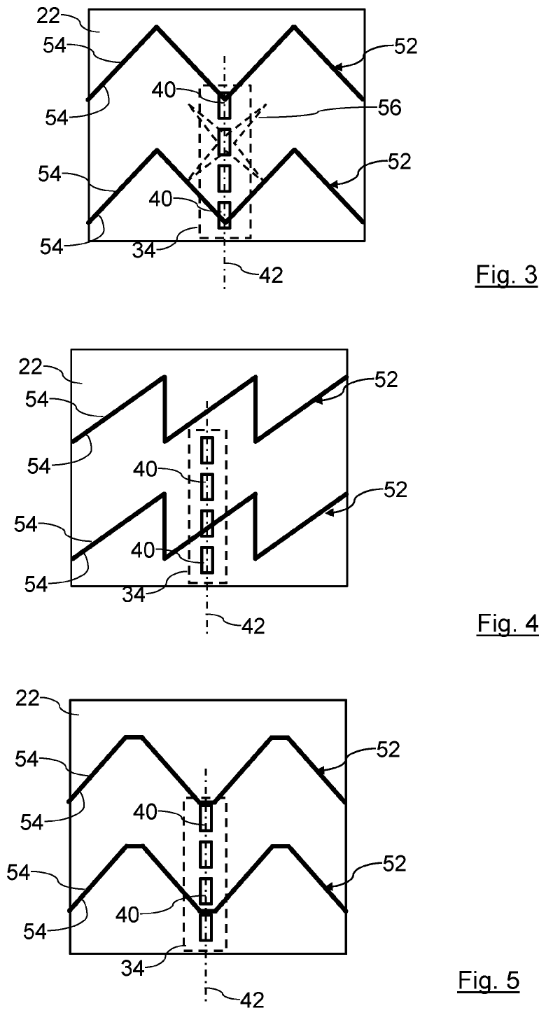

The heating wires 52 are located in the receiver light path 38 and thus likewise act as light diffraction elements for the reception light signals 32. The upper peripheries of the heating wires 52 in FIGS. 2 and 3 in each case form boundary peripheries 54. The heating wires 52 and the boundary peripheries 54 have a zigzag-shaped profile. The boundary peripheries 54 do not in any portion extend perpendicularly to the receiver axis 42 viewed in the projection onto the receiver 34. In this way it is ensured that expansions of the diffraction patterns, caused by the boundary peripheries 54, in the reception regions 40 in the direction of the receiver axis 42 are reduced.

Rather than one common window 22 for transmission light signals 30 and reception light signals 32, separate transmission windows and reception windows may be provided.

During a measurement with the measurement apparatus 14, transmission light signals 30 are produced with the transmission device 24 and transmitted through the window 22 into the monitoring region 16.

The reception light signals 32 reflected at an object 18 initially pass through the window 22. In the process, diffraction patterns are produced at the boundary peripheries 54 of the heating wires 52. Owing to the zigzag-shaped profile of the boundary peripheries 52, the diffraction patterns extend substantially at an angle with respect to the receiver axis 42.

The reception light signals 32 are focused onto the receiver 34 using the reception lens 36. In the process, diffraction patterns are produced at the boundary peripheries 50 of the masks 44. Owing to the zigzag-shaped profile of the boundary peripheries 50, the diffraction patterns extend substantially at an angle with respect to the receiver axis 42.

Depending on the height at which the object 18 is located, the corresponding reception light signals 32 illuminate the receiver 34 at the corresponding height in a full-illumination region 56, which is indicated in FIG. 2. The shape of the full-illumination region 56 is influenced by the diffraction patterns produced at the boundary peripheries 50 and 54. FIG. 3 indicates, by way of example, the full-illumination region 56 merely for illustration purposes in the form of a star, wherein the spikes of the star in each case extend at an angle with respect to the receiver axis 42. The actual shape of the full-illumination region 56 depends, among other things, on the profile of the boundary peripheries 50 and 54 and their arrangement. In FIG. 3, the illustration of the reception lens 36 and of the transmission device 24 is omitted for the sake of clarity.

Owing to the reduction according to the invention of the extent of the above-described diffraction patterns in the direction of the receiver axis 42, the full-illumination region 56 fully illuminates only the second reception regions 40 from the top in the exemplary embodiment shown. The in each case zigzag-shaped profile of the boundary peripheries 50 and 54 ensures that no crosstalk, or at least greatly reduced crosstalk, to the adjacent, specifically the first and the third reception regions 40 from the top occurs.

Height information relating to the object 18 can be acquired from the reception light signals 32, which are captured with the reception region 40 that is struck by the full-illumination region 56.

FIG. 4 shows a window 22 with heating wires 52 according to a second exemplary embodiment. The elements that are similar to those of the first exemplary embodiment from FIGS. 2 and 3 are provided with the same reference signs. The second exemplary embodiment differs from the first exemplary embodiment in that the heating wires 52 extend in a sawtooth shape.

FIG. 5 shows a window 22 with heating wires 52 according to a third exemplary embodiment. The elements that are similar to those of the first exemplary embodiment from FIGS. 2 and 3 are provided with the same reference signs. The third exemplary embodiment differs from the first exemplary embodiment in that the zigzag-shaped heating wires 52 have flattened tips in their reversal points. By way of example, more than 7/10 of the extent of the respective boundary peripheries 54 do not extend perpendicularly to the receiver axis 42 viewed in the projection onto the receiver 34.

FIG. 7 shows a reception lens 36 with masks 44 and a receiver 34 of a measurement apparatus 14 according to a fourth exemplary embodiment. The elements that are similar to those of the first exemplary embodiment from FIGS. 2 and 3 are provided with the same reference signs. The fourth exemplary embodiment differs from the first exemplary embodiment in that the reception regions 40 of the receiver 34 are arranged two-dimensionally in rows and columns. The receiver 34 has a vertical reception axis 42a and a horizontal reception axis 42b. Using the two-dimensional receiver 34, spatially horizontal and spatially vertical direction information relating to the object 18 relative to the measurement apparatus 14 can be ascertained.

In order to reduce in respective measurements the influence of diffraction patterns brought about by the lateral peripheries 58 of the receiver lens 22 on the extent of the respective full-illumination regions, the lateral peripheries 58 are covered with in each case vertically extending masks 44. The lateral masks 44 have, similar to the horizontally extending masks 44 at the upper periphery 46 and the lower periphery 48, in each case zigzag-shaped boundary peripheries 54.

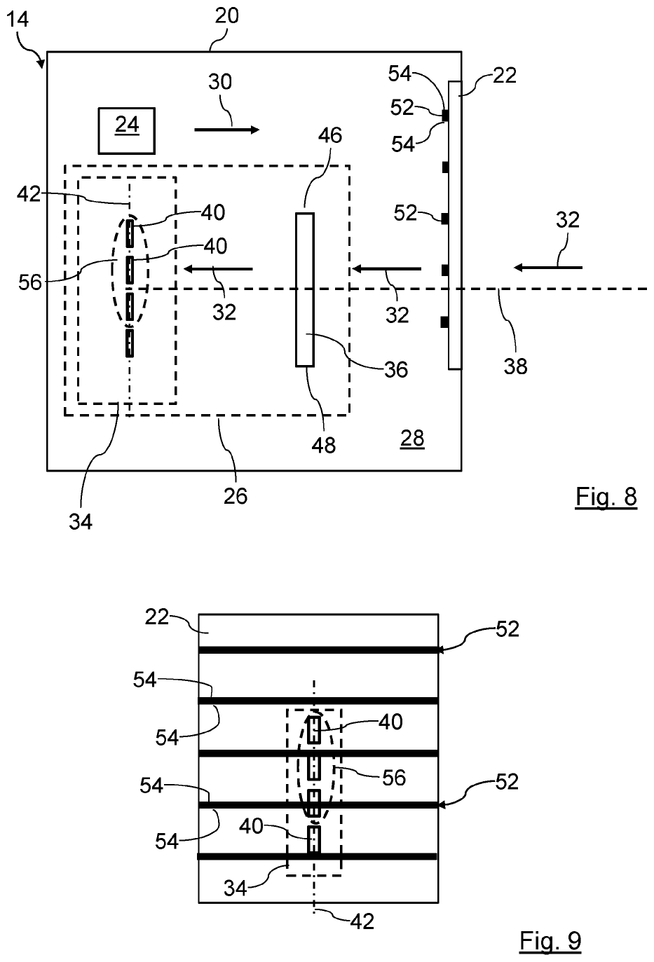

FIGS. 8 and 9 show merely for comparison purposes a measurement apparatus 14 that is not in accordance with the invention, in which the heating wires 52 do not extend in a zigzag shape but straight and perpendicularly to the receiver axis 42 viewed in the projection, that is to say not in accordance with the invention. Without the masks 44, the upper periphery 46 and the lower periphery 48 extending perpendicularly to the receiver axis 42 viewed in the projection bring about diffraction patterns that expand the full-illumination region 56 in the direction of the receiver axis 42 for example over three reception regions 40. This results in crosstalk of the reception light signals 32 for example into the first and the third reception region 40 from the top and thus to a loss of accuracy when determining the height information of objects 18.

1. An optical measurement apparatus for determining object information of objects in at least one monitoring region, the optical measurement apparatus comprising:
at least one reception device for receiving light signals coming from at least one object,
wherein the at least one reception device comprises at least one electro-optical receiver for converting light signals into electrical signals,
wherein at least one light diffraction element is arranged in a receiver light path of the at least one reception device upstream of the at least one receiver,
wherein the at least one electro-optical receiver has a plurality of reception regions arranged one behind another viewed in the direction of at least one receiver axis and that are evaluated separately with respect to the respectively received light intensity, and
wherein at least one boundary periphery of at least one light diffraction element at least regionally does not extend perpendicularly to the at least one receiver axis viewed in the projection onto the at least one receiver.

2. The optical measurement apparatus according to claim 1, wherein
the at least one boundary periphery of the at least one light diffraction element is at least one periphery of at least one optical lens,
a periphery of a stop or mask,
a periphery of a heating wire, or a periphery of a window of a housing of the measurement apparatus.

3. The optical measurement apparatus according to claim 1, wherein more than 7/10 of the extent of at least one boundary periphery of at least one light diffraction element do not extend perpendicularly to the at least one receiver axis viewed in the projection onto the at least one receiver.

4. The optical measurement apparatus according to claim 1, wherein at least one boundary periphery of at least one light diffraction element extends at least regionally in a zigzag shape and/or at least regionally in a wave shape and/or at least regionally in a zigzag shape with flattened and/or rounded tips and/or at least regionally has a free curve profile.

5. The optical measurement apparatus according to claim 1, wherein the optical measurement apparatus has a housing in which at least one reception device is arranged, and the housing has at least one window through which light signals passes from the monitoring region to the at least one reception device.

6. The optical measurement apparatus according to claim 1, wherein the at least one receiver has a plurality of individual reception elements with in each case at least one reception region and/or the at least one receiver has at least one line-type or area-type arrangement of a plurality of reception regions.

7. The optical measurement apparatus according to claim 1, wherein at least one rectangular or square optical lens is arranged in the receiver light path.

8. The optical measurement apparatus according to claim 1, wherein the optical measurement apparatus is configured for determining at least one direction of at least one captured object relative to the measurement apparatus.
